(19) United States
(12) Patent Application Publication
(10) Pub. No.: US 2020/0141014 A1
(43) Pub. Date: May 7, 2020

(54) METHOD FOR THE OXIDATION AND HYDROTHERMAL DISSOCIATION OF METAL CHLORIDES FOR THE SEPARATION OF METALS AND HYDROCHLORIC ACID

(71) Applicant: 9203-5468 QUEBEC INC. DBA NMR360, Westmount (CA)

(72) Inventors: Bryn Harris, Alexandria (CA); Carl White, Ville St-Laurent (CA)

(21) Appl. No.: 16/736,441

(22) Filed: Jan. 7, 2020

Related U.S. Application Data
(63) Continuation of application No. PCT/CA2018/050799, filed on Jun. 28, 2018.
(60) Provisional application No. 62/529,571, filed on Jul. 7, 2017.

(51) Int. Cl. C25B 1/26; C22B 3/44; C01G 49/06; C01B 7/03; C01F 7/30

(52) U.S. Cl. CPC C25B 1/26; C22B 3/44; C01F 7/306; C01B 7/035; C01G 49/06

(57) ABSTRACT

A process is disclosed for the oxidation and thermal decomposition of metal chlorides, leading to an efficient and effective separation of nuisance elements such as iron and aluminum from value metals such as copper and nickel. In the first instance, oxidation, especially for iron, is effected in an electrolytic reactor, wherein ferrous iron is oxidised to ferric. In a second embodiment, the oxidised solution is treated in a hydrothermal decomposer reactor, wherein decomposable trivalent metal chlorides form oxides and divalent metal chlorides form basic chlorides. The latter are soluble in dilute hydrochloric acid, and may be selectively re-dissolved from the hydrothermal solids, thereby effecting a clean separation. Hydrochloric acid is recovered from the hydrothermal reactor.

### CROSS-REFERENCE TO RELATED APPLICATIONS

The present patent application is a continuation of International patent application no. PCT/CA2018/050799 filed on Jun. 28, 2018, which claims the benefits of priority of U.S. Provisional Patent Application No. 62/529,571 filed at the United States Patent and Trademark Office on Jul. 7, 2017, the content of which is incorporated herein by reference.

### FIELD OF THE INVENTION

The present invention relates to a method for the oxidation of base metals and ferrous iron and processes for the separation and recovery of metals and hydrochloric acid. More specifically, the process relates to the oxidation of ferrous chloride, separation of iron from base metals, and recovery of hydrochloric acid.

### BACKGROUND OF THE INVENTION

Despite the many obvious chemical advantages of using chloride-based hydrometallurgical techniques for recovering metals such as zinc, nickel, copper, cobalt, lead, aluminum, titanium, and magnesium from sulphide and oxide ores, concentrates and intermediates, the metals extraction industry has been reluctant to embrace chloride processes. The reason for this is primarily economic, since hydrochloric acid is much more costly than its sulphuric acid counterpart, costing 3-4 times as much on an equivalent hydrogen ion basis, and hence must be recovered and recycled in the process flowsheet. There is also an environmental component, since iron residues from conventional atmospheric chloride processes tend to be more difficult to handle and dispose of than their counterparts from sulphate processes.

In this context, however, most base metal chlorides are generally much more amenable to hydrolysis than the corresponding sulphates, especially at higher temperatures (>100° C.), forming an oxide or hydroxide, and releasing the chloride ion, making it potentially available for recovery. The following discussion applies principally to chloride-based leach solutions.

Chloride-based leaching systems are aggressive, resulting in substantially all of the metals in the feed material being dissolved. This is especially true for iron, which is and has always been considered a major problem in hydrometallurgical processes, usually being present in process solutions in concentrations much greater than the value metals which are the primary target of any process. Moreover, the iron is usually present in both oxidized and reduced forms, and very rarely is it present solely in its ferric (higher oxidation state and less stable form).

The first objective of most processes, therefore, is to remove iron prior to recovering the target metals. A. J. Monhemius, in an article entitled “Precipitation Diagrams for Metal Hydroxides, Sulphides, Arsenates and Phosphates”, published in Transactions of IMM, Volume 86, Section C, December 1977, p. C202, reported on the theoretical order of precipitation of various metal hydroxides. This was based on the solubility product (Kₛₚ) of the metal hydroxide, and the dissociation constant of water (K_{w}), using the following equation, where M is any metal of valency n+:

pH=(log Kₛₚ−n log K_{w}−log[Mⁿ⁺])/n

From this analysis, it was determined that the trivalent and tetravalent metals precipitated at the lowest pH, whereas magnesium, and especially calcium, were the hardest to hydrolyse.

In atmospheric processes, iron is usually precipitated as an oxy-hydroxide, where a base such as caustic soda, magnesia or lime is added, since water itself is not sufficiently active to promote hydrolysis. Often, small amounts of copper are added to act as a catalyst in the oxidation of ferrous to ferric. One method of controlling iron in chloride-based solutions is to form FeOOH, either β-FeOOH (akaganeite) or α-FeOOH (goethite) as described by D. Filippou and Y. Choi, in “A Contribution to the Study of Iron Removal From Chloride Leach Solutions”, in Chloride Metallurgy 2002, Volume 2, (E. Peek and G. van Weert, Editors), Proceedings of the 32^{nd} Annual CIM Hydrometallurgical Conference, C, Montreal (2002), p. 729. This approach is based to some extent on a controlled supersaturation precipitation technique, and is more efficient than, for example, the turboaeration process proposed by Great Central Mines in their chloride copper process, as described by R. Raudsepp and M. J. V. Beattie, in “Iron Control in Chloride Systems, in Iron Control in Hydrometallurgy” (J. E. Dutrizac and A. J. Monhemius, Editors), Proceedings of 16^{th} Annual CIM Hydrometallurgical Meeting, Toronto, October 1986, CIM Montreal (1996), p. 163. A major disadvantage, however, of forming akaganeite is a loss of chloride, since akaganeite precipitates can contain up to 7% chloride.

In higher temperature, higher pressure processes, water becomes sufficiently active, and iron can be precipitated as its oxide, an impure hematite. However, in typical aqueous solutions, expensive autoclave pressure vessels are required to achieve this, and the corresponding chloride cannot be recovered as hydrochloric acid.

There are two fundamental issues associated with removing iron from chloride process liquors. The first is that, following the sequence outlined above by Monhemius, any ferrous iron needs to be oxidised to ferric before hydrolysis can be effected. The second is that the chloride component associated with the iron (and other base metal chlorides) needs to be recovered in a useful form as hydrochloric acid, rather than an alkali or alkaline earth metal chloride as would be the case with caustic or lime-induced hydrolysis. Most metal chloride leaching solutions are combinations of iron and value metals such as nickel, cobalt, copper, zinc and lead, together with gangue metals such as aluminum, magnesium and calcium.

Ferrous chloride solution, containing minor amounts of steel alloys such as manganese, vanadium and nickel, is the principal by-product of steel pickling lines (commonly referred to as waste pickle liquor, WPL). This solution is generally treated by a process called pyrohydrolysis, wherein the solution is injected into hot combustion gases at 700-900° C., causing the simultaneous oxidation of the ferrous iron to ferric and subsequent decomposition to recover hydrochloric acid and generate an iron oxide product. The strength of the hydrochloric acid recovered from this process is limited to 18% because the off-gases have to be quenched in water, and using this method it is impossible to exceed the azeotropic concentration of hydrochloric acid in water, 20.4%.

Pyrohydrolysis is limited to predominantly ferrous chloride solutions, being highly ineffective if the iron is the ferric form. It is also non-discriminatory, since any other hydrolysable metals in solution, such as aluminum, magnesium, nickel, cobalt and manganese will also convert to their respective oxides. Non-hydrolysable metals, such as calcium, sodium and potassium simply report to the solids as unreacted chlorides. Zinc chloride is a special case, with solutions containing zinc not treatable by this technique due to the zinc chloride becoming very sticky and blocking up the nozzles and valves in the reactor. Recovery of associated metals from pyrohydrolysis solids is difficult due to their refractory nature. Consequently, the other pickle liquor from the steel industry, ZPL, zinc pickle liquor solution is usually disposed of in deep wells. There is not, at present, any commercially-viable process for treating ZPL.

U.S. Pat. No. 3,682,592 issued to Kovacs describes a process, the PORI Process, for recovering HCl gas and ferric oxide from waste hydrochloric acid steel mill pickle liquors (WPL). WPL typically contains water, 18 to 25% weight of ferrous chloride (FeCl₂), less than 1%) weight ferric chloride (FeCl₃), small amounts of free hydrochloric acid and small amounts of organic inhibitors. The process of Kovacs includes two steps namely, a first oxidation step and a second thermal hydrolysis step. During the first oxidation step, the ferrous chloride in the WPL is oxidized using free oxygen to obtain ferric oxide and an aqueous solution containing ferric chloride. No hydrochloric acid is liberated at this stage. The first oxidation step is carried out under pressure (preferably, 100 p.s.i.g.) and at an elevated temperature (preferably, 150° C.), and therefore requires an autoclave.

During the second step, the resultant ferric chloride solution is hydrolysed to obtain ferric oxide and HCl gas, which is recovered as hydrochloric acid. More specifically, the resultant solution is heated up to 175-180° C. at atmospheric pressure, and hydrolysis effected by the water in the fresh ferric chloride being added. The HCl is stripped off at a concentration of 30% with >99% recovery and good quality hematite is produced.

While recovery of hydrochloric acid and hematite may be achieved using this process, its application tends to be limited to liquors containing only ferrous/ferric chlorides. It has been found that when other metal chlorides are present in the solution, which is always the case in steel pickling, where manganese and nickel often occur, then the freezing or “drying-out” temperature of the ferric chloride solutions starts to drop as the concentration of other metals increases. It has been seen that when the other metals chlorides reach about 30% in concentration, the balance being ferric chloride, then the temperature specified by Kovacs cannot be attained whilst at the same time keeping the system liquid, and the reaction stops.

SMS Siemag of Vienna, Austria, published a paper describing a process almost identical to that of Kovacs. The paper, “Regeneração Hidrotérmica De Àcido Um Modo Econômico De Regenerar Liquidos De Decapagem E Produzir Oxidos Ferricos De Alta Qualidade”, published in Portuguese by D. Vogel, et al., follows the same procedures as Kovacs. More recently, a patent application describing the SMS Siemag process has been published by N. Takahashi et al., entitled “Processing Method for Recovering Iron Oxide and Hydrochloric Acid”, International Patent Application no. WO 2009/153321 A1, Dec. 23, 2009. A further identical patent is one published by Kazuo Handa, Murakami KeiHiroshi, Nobuo Nonaka, and Takahashi ShinYoshimi, as JP 2004-137118 A (in Japanese), entitled “Process for the Recovery of Hydrochloric Acid from Iron Treatment with Hydrochloric Acid Waste Liquid”, published on 13 May 2004.

In these processes, it is specified that the ferric chloride of the bath into which fresh aqueous ferric chloride is injected, should be kept at around a concentration of 65% ferric chloride and 35% water. This obviously means that not all of the iron is hydrolysed, with a substantial amount remaining in this liquid phase of 65% ferric chloride. This, in turn, indicates that a significant proportion of the chloride is also not recovered, which mitigates against the objectives of the process.

SMS Siemag built a plant based on this patent, but found that it did not work, since there were too many operational difficulties. The reasons and the type of problems encountered were described in a paper by Herbert Weissenbaeck, Benedikt Nowak, Dieter Vogl and Horst Krenn, entitled “Development of Chloride Based Metal Extraction Techniques: Advancements and Setbacks”, published at ALTA Nickel-Cobalt-Copper Conference, Perth, Wash., May 28, 2013. Specifically, it was found that the plant worked well at first, but then the freezing problems indicated in paragraph 14 started to happen.

The present applicants published a method a method for overcoming the limitations in both the ferrous iron oxidation and ferric iron hydrolysis in US Patent Application 2013/0052104 A1, “Process For the Recovery of Metals and Hydrochloric Acid”, Feb. 28, 2013. Oxidation was effected by injecting air or oxygen into a novel column reactor at a temperature of 135° C. In this process, a matrix solution is used, described as being any compound which is capable of being oxygenated to form, even transiently, a hypochlorite compound. The matrix solution performed two duties, the first being the hypochlorite formation just referred to, and the second remaining liquid over the temperature range of 135-190° C. This was important, since hematite, the desired form of iron oxide, is not formed easily at lower temperatures, whereas the precursor, ferrous chloride, evaporates to dryness at a temperature around 109° C.

It has been discovered since, however, that the column reactor has some limitations, particularly in the volume of gas that can be blown through it. Whilst air may be used on small reactors, the volumes of nitrogen present preclude its use in larger reactors, where the surface area to volume ratio is very much lower. In these cases, blowout of the reactants tends to occur.

A second drawback is the formation of hypochlorites referred to above. A major issue in this respect is calcium, its hypochlorite being a very common chemical. Calcium is almost ubiquitously present in mineral ores and concentrates, and hence will almost certainly be present in any processing solution. Complete (100%) removal, as gypsum or other forms of calcium sulphate, is not possible, and thus some calcium will always be present. It has been found that calcium hypochlorite forms at the lower end of the temperature spectrum above, and tends to explosively decompose at 155-160° C. Hence, the system is not practical if significant calcium concentrations are allowed to build up, which will be the case, since calcium chloride does not hydrolyse.

A third drawback of using oxygen at such temperatures is the formation of elemental chlorine through the Deacon Reaction. This reaction was the original method of generating chlorine, using oxygen to react with HCl to form water and chlorine. Small concentrations, up to 300 mg/L, of chlorine have been found in the recovered hydrochloric acid, indicating that the Deacon Reaction does occur.

In terms of ferric iron hydrolysis, the US patent application cited above indicated that zinc chloride was a preferred matrix solution for effecting this because of its ability to remain liquid over a large temperature range, and more importantly, to remain inert. However, since the application was filed, it has been found that the presence of calcium, again, and/or magnesium has had unforeseen consequences. Calcium chloride on its own evaporates to dryness at around 185-190° C., and magnesium chloride on its own at 195-200° C. However, if either is allowed to build up to a significant (>30%) concentration in zinc chloride, then at temperatures over 210° C., the system remains liquid and white solids are formed having an analysis of 65% Zn, indicating zinc hydrolysis forming either tetra basic zinc chloride (Zn₅(OH)₈Cl₂) or zinc hydroxy chloride (ZnOHCl) or a combination of both.

A further disadvantage of the above system, and also of those of SMS Siemag and PORI, is that there is no obvious end-point of the reaction. As noted, the PORI and SMS Siemag systems require a residual ferric chloride of 65%, such that an end-point can never be achieved. With the zinc chloride matrix system, there is always, and constantly, some dissolution of feed solution into the matrix itself, resulting in a continuously changing composition. Several secondary reactors are required, wherein the temperature is changed and additional steam injection carried out to recover residual metals. Even so, complete is recovery is not possible, because there is always some residual solubility.

In light of the foregoing, it is clear that there is no full understanding of, or simple methodology by which ferrous iron can be easily oxidized, nor can such oxidation be coupled with the separation of iron and other nuisance chlorides from base metal chlorides and at the same time effect the recovery hydrochloric acid. Thus, there is needed a clear method of effecting iron oxidation under all process conditions, and allowing for the subsequent recovery of both hydrochloric acid and base metals. In light of the foregoing, it would be advantageous to be able to oxidise ferrous iron without the use of an either an autoclave or large volumes of oxygen and/or air, and furthermore without the intermediate formation of hematite with its attendant propensity to scale. So doing would lead to a much more simple process for the recovery hydrochloric acid, result in complete recovery of iron as an oxide, and effect separation of iron from base metals.

### SUMMARY OF THE INVENTION

In accordance with a broad aspect of the present invention, processes for separating nuisance elements such as iron and aluminum from more valuable base metals, and for recovering hydrochloric acid from any chloride-based feed solution are disclosed. Such solution may have been generated by treating any base or light metal-containing material with any lixiviant comprising acid and a chloride, but in particular with hydrochloric acid generated and recycled within the process, or WPL or ZPL. The chloride solution is then treated to separate and recover therefrom hydrochloric acid and metal oxides as separate discrete products.

The invention is directed to a process for the oxidation of ferrous iron in chloride solutions and recovery of hydrochloric acid, comprising:
i. feeding a solution containing ferrous chloride and hydrochloric acid into a reactor having an anode and a cathode;
ii. applying a current to the anode and cathode to cause oxidation of the hydrochloric acid forming reactive monatomic chlorine, which immediately reacts with the ferrous iron oxidising it to ferric;
iii. heating of the so-formed ferric chloride-containing solution to effect hydrothermal decomposition of the metal chlorides contained in the solution, evolving hydrochloric acid and forming a mixture of metal oxides and basic chlorides;
iv. quenching of the so-formed decomposition slurry in dilute hydrochloric acid, wherein the basic metal chlorides re-dissolve; and
v. proceeding with solid-liquid separation of the quench slurry for the recovery of metal oxides.

According to a preferred embodiment, in step (i) of the process, a molar ratio of ferrous iron to hydrochloric acid is >1. Preferably, an excess hydrochloric acid may be used to maintain the pH <2.0 to prevent subsequent ferric iron hydrolysis.

According to a preferred embodiment, in step (ii) of the process, a residual ferrous iron concentration is maintained in the range 0.5-5.0 g/L, more preferably in the range 0.5-1.0 g/L.

According to a preferred embodiment, in (ii), a feed temperature is from ambient to boiling.

According to a preferred embodiment, in (ii), the current has a density of from 50-500 A/m², more preferably the current density is 300-350 A/m².

According to a preferred embodiment, in (iii), the ferric solution also contains a metal chloride which remains liquid at a temperature of 180-190° C. More preferably, the metal chloride is magnesium, calcium, or zinc.

According to a preferred embodiment, in (iii), the solution also contains one, any or all of aluminum, cobalt, nickel, copper, lead, manganese, titanium, or vanadium.

According to a preferred embodiment, in (iii), the temperature is raised to 180-190° C.

According to a preferred embodiment, in (iii), trivalent and higher valent metals form their oxides, which are insoluble in dilute hydrochloric acid. More preferably, iron forms hematite and aluminum forms alumina.

According to a preferred embodiment, in (iii), divalent metals form their basic metal chlorides, which are readily soluble in dilute hydrochloric acid.

According to a preferred embodiment, in (iii), alkali metal chlorides and calcium chloride remain as chlorides, and zinc remains as a chloride.

According to a preferred embodiment, in (iii), the hydrochloric acid is condensed and recycled within the process.

According to a preferred embodiment, in (iii), the reaction is allowed to go to completion, denoted by no more HCl gas being evolved.

The process allows for the oxidation and thermal decomposition of metal chlorides, leading to an efficient and effective separation of nuisance elements such as iron and aluminum from value metals such as copper and nickel. In the first instance, oxidation, especially for iron, is effected in an electrolytic reactor, wherein ferrous iron is oxidised to ferric. In a second embodiment, the oxidised solution is treated in a hydrothermal decomposer reactor, wherein decomposable trivalent metal chlorides form oxides and divalent metal chlorides form basic chlorides. The latter are soluble in dilute hydrochloric acid, and may be selectively re-dissolved from the hydrothermal solids, thereby effecting a clean separation. Hydrochloric acid may be recovered from the hydrothermal reactor.

Other and further aspects and advantages of the present invention will be better understood upon the reading of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 shows a schematic for the oxidation of ferrous iron.

FIG. 2 shows a schematic for the hydrothermal decomposition of metal chlorides and recovery of hydrochloric acid.

### DETAILED DESCRIPTION OF EMBODIMENTS OF THE INVENTION

A novel process will be described hereinafter. Although the invention is described in terms of specific illustrative embodiments, it is to be understood that the embodiments described herein are by way of example only and that the scope of the invention is not intended to be limited thereby.

The terminology used herein is in accordance with definitions set out below.

As used herein % or wt. % means weight % unless otherwise indicated. When used herein % refers to weight % as compared to the total weight percent of the phase or composition that is being discussed.

By “about”, it is meant that the value of weight % (wt. %), time, pH, volume or temperature can vary within a certain range depending on the margin of error of the method or device used to evaluate such weight %, time, pH, volume or temperature. A margin of error of 10% is generally accepted.

The description which follows, and the embodiments described therein are provided by way of illustration of an example of particular embodiments of principles and aspects of the present invention. These examples are provided for the purposes of explanation and not of limitation, of those principles of the invention. In the description that follows, like parts and/or steps are marked throughout the specification and the drawing with the same respective reference numerals.

In accordance with a broad aspect of the present invention, there is a process described for oxidising ferrous iron and recovering hydrochloric acid from a chloride-based feed solution containing ferrous iron. Such solution may have been generated by treating any base, precious or light metal-containing material with any lixiviant comprising acid and a chloride, but in particular with hydrochloric acid generated and recycled within the process, or being derived from SPL or ZPL. It is understood that whilst the description references ferrous iron, which is by far the most common metal requiring oxidation, the principals and practice equally apply to other metals requiring oxidation such as, but not limited to, copper or manganese.

It is a particular aspect of the invention that ferrous iron oxidation is effected without either recourse to the use of an autoclave, the need to pre-evaporate the incoming solution, or without the need to use a matrix which has to be oxygenated to form an intermediate hypochlorite.

Ferrous chloride solution, on its own (i.e. no other ions present), cannot be raised to a temperature above 120° C. under atmospheric conditions, such that oxidation with oxygen or air is both difficult and very slow. Even under favourable conditions, such as in an autoclave, oxidation with oxygen or air promotes the reaction wherein one third of the iron is converted to hematite solids. Handling such solids can be problematical, especially in terms of scaling and abrasion of valves, such as encountered by SMS Siemag in the publication referenced above. Hematite, especially in the nickel laterite industry, is well-known for its propensity to cause scaling.

To avoid these problems, namely the need for pre-concentration or the use of an autoclave, along with the formation of abrasive solids, the present invention makes use of the fact that free hydrochloric acid in the ferrous solution may be electrolytically oxidised (at the anode) to form elemental chlorine. Such chlorine, the moment it is formed, is highly reactive due to being in a monatomic state, so-called “nascent” chlorine. The reaction, in a simple form, is shown in equation (1):

2HCl→Cl₂+H₂ (1).

The hydrogen produced (at the cathode) is also reactive, and spontaneously reacts with dissolved oxygen in the solution to form water. Alternatively, a stream of air may be blown across the cathode to remove the hydrogen and depolarise it.

The reactive chlorine reacts instantaneously with ferrous iron to form ferric iron, according to equation (2):

2FeCl₂+Cl₂→2FeCl₃ (2).

It is a particular aspect of this invention that in this case, the oxidation of ferrous is effected in-situ without the formation of any hematite solids, and also without the need for any elevated temperature.

However, care has to be taken, since an additional reaction may take place at the cathode, as shown in equation (3), namely the formation of metallic iron:

FeCl₂→Fe+Cl₂ (3)

The formation of metallic iron is highly undesirable for two reasons, namely that it plates on the cathode, thereby reducing the effectiveness of the cathode, and secondly, it has a very high power consumption compared to equation (1). It has been found, therefore, that it is essential to maintain a residual level of ferrous iron in solution, from 0.5-5.0 g/L, optimally from 0.5-1.5 g/L.

A further advantage of carrying out the ferrous iron oxidation in this manner is that there is no longer any need to adjust the solution composition to maintain the 145-155° C. temperature range required by the current processes, whether it be by an autoclave or by the use of a matrix. This further means that the need to inject steam is no longer required, and that the composition of the feed solution may be adjusted prior to the subsequent hydrolysis reaction in such a manner as to generate the required composition of HCl directly off the reactor. In other words, the amount of water required for the hydrolysis reaction is derived entirely from the incoming feed solution, and thus the need to inject steam for the hydrolysis reaction to occur is eliminated.

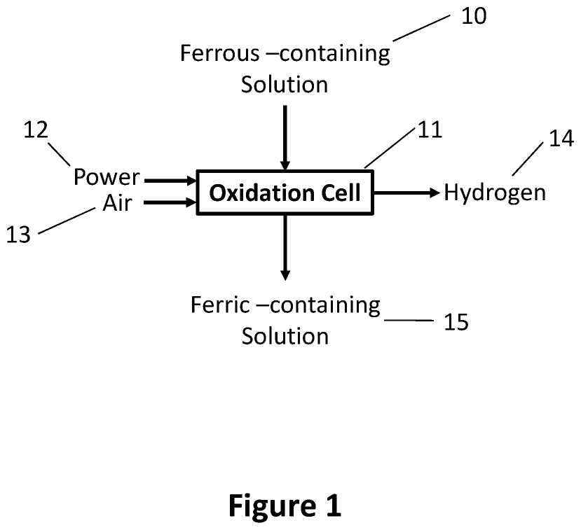

Referring to FIG. 1, feed solution 10 containing some ferrous iron is fed into an electrolytic oxidation reactor 11. The temperature of the feed solution may be from ambient to boiling, being whatever the process step which generated it operates at. The oxidation reaction is exothermic, however, and under steady state conditions, the temperature of the reactor will operate at 100-160° C. or higher, depending on the initial iron concentration and temperature of the feed solution 10. The presence of the formed ferric iron permits the temperature to exceed the boiling point of pure ferrous chloride solution.

A condition is that the solution contains a molar ratio of free hydrochloric acid to ferrous iron >1 (i.e. HCl/Fe(II)≥1). This is necessary in order to supply the requisite amount of chloride ion to effect the oxidation. Ideally, the excess hydrochloric acid will be 5-25%, sufficient to maintain the pH of the resultant ferric chloride at ≤2.0 in order to prevent premature ferric iron hydrolysis.

Any simple electrolytic cell 11 may be used, but the preferred configuration is that of a bipolar cell, with a header on the cathodic compartments to collect any hydrogen formed.

The anodic current density 12 should be in the range 50-500 A/m², the actual value being dependent upon the ferrous iron concentration and the desired kinetics. Typically, the value will be 300-350 A/m².

Hydrogen 14 is liberated from the cathodic compartment of the cell. Stripping of the hydrogen may be facilitated by a small stream of air blown across the faces of the cathodes into a header. Some hydrogen will react to form water with dissolved oxygen, but the balance may be collected by any conventional means, such as absorption by palladium metal. The predominant purpose of the air is to depolarise the cathode, and therefore lower the power consumption.

Oxidised solution 15 is withdrawn from the anodic compartment of the cell.

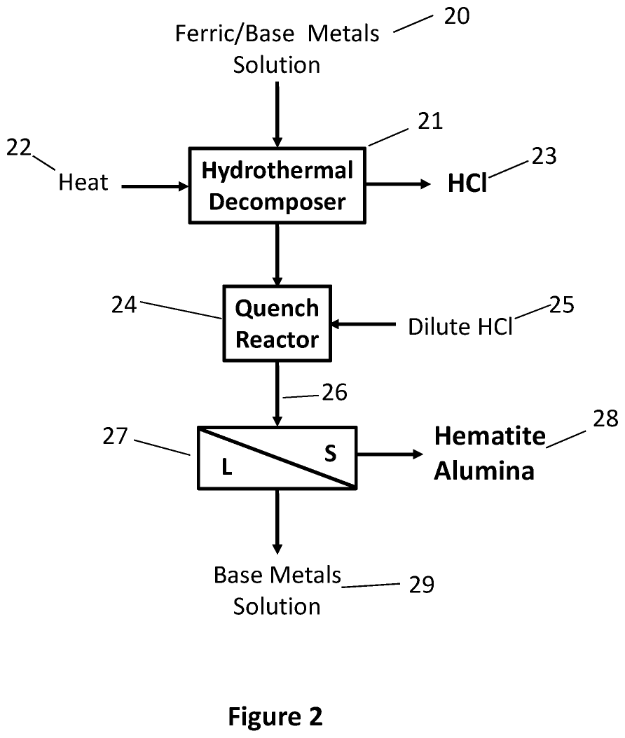

Turning to FIG. 2, there is shown a schematic representation of a method for hydrothermally decomposing an oxidised metal chloride solution. In the present embodiment, the feed solution 20 is one that might result form the leaching of a laterite or polymetallic base metal sulphide ore.

The feed solution 20 is fed into a hydrothermal decomposer reactor 21 wherein the temperature is raised to 170-200° C., preferably 175-185° C. It is a condition of the invention that the feed solution contains one of, all of, or a combination thereof of magnesium, calcium or zinc, since the presence of these metals do not decompose under these conditions, and will ensure that the solution does dry out in the decomposer. These metals should comprise at least 10%, and preferably >30% of the overall metal concentration.

The hydrothermal decomposer reactor 21 may be any agitated vessel, and is preferably acid-brick lined, more preferably with fused alumina. Agitation is necessary, especially if the reactor is externally heated, in order to prevent scaling on the walls. In practice, a cascade of several reactors is required to ensure sufficient residence time for the reactions of (4) and (5) below to reach completion. The end-point of the reaction is simply determined in that no further generation of HCl gas is observed. This is a very simple and easily-observed end-point, unlike what is observed with those processes discussed in the Background section.

Raising the temperature causes the thermal decomposition of the metal chlorides. The temperature may be raised by heat 22 through an external heat exchanger, or by the addition of steam, or by a jacketed heated vessel. As the metal chlorides decompose, HCl vapour 23 is formed and condensed in any suitable off-gas system. The strength of the HCl vapour is directly proportional to the decomposable metals concentration of the incoming feed solution 20. The following equations show the reactions for iron, aluminum (trivalent metals), copper and nickel (divalent metals):

2FeCl₃+3H₂0→Fe₂0₃+6HCl (4)

2AlCl₃+3H₂O→Al₂O₃+6HCl (5)

2CuCl₂+3H₂O→Cu(OH)₂.Cu(OH)Cl+3HCl (6)

2NiCl₂+3H₂O→Ni(OH)₂.Ni(OH)Cl+3HCl (7).

Theoretically, it is possible to selectively decompose the metals in order, according to the order indicated by Monhemius referenced in paragraph 5. However, in practice it is difficult to do so, and nor is it necessary, since the base metals form basic chlorides, and these readily re-dissolve in dilute hydrochloric acid.

As the metals decompose, the non-reactive metal chlorides (calcium, magnesium and zinc) increase in composition, and the reactor is allowed to overflow into a quench reactor 24, containing dilute hydrochloric acid 25 and operating at atmospheric conditions. The basic chlorides re-dissolve, whereas the metal oxides do not, and in this way, copper and nickel are effectively separated from iron and aluminum, and the associated hydrochloric acid recovered for recycle.

The strength of the dilute hydrochloric acid is sufficient to re-dissolve the base metals. The background metal chlorides which had not decomposed are allowed to build up to a suitable concentration to allow further processing. For example, in the case of magnesium, this would be 300-350 g/L MgCl₂, and for zinc chloride 200-250 g/L.

Solid-liquid separation 27 of the quench reactor slurry 26 may be effected by any convenient means, such as, but not limited to, flocculation and thickening, filter press or vacuum belt filter. The solids 28 are a mixture of metal oxides, primarily, but not limited to, hematite and alumina. The solution 29 contains base metals and the non-decomposable metal chlorides, which may be processed by conventional means for the recovery of the separate metals.

Carrying out the quench reaction in this way thereby solves the issues which were paramount with the PORI and SMS Siemag Processes, and which ultimately resulted in their downfall. In the present invention, solid-liquid separation is carried out at ambient and atmospheric temperatures, which is a very simple and effective operation, whereas in the other processes, it has/had to be carried out at 170-180° C., with the attendant potential for freezing, particularly of the various valves involved.

The objective of this process has been to have an effective and efficient separation of value metals such as nickel and cobalt, from nuisance elements such as iron and aluminum, and at the same time recover the associated hydrochloric acid for recycle.

The principles of the present invention are illustrated by the following examples, which are provided by way of illustration, but should not be taken as limiting the scope of the invention.

### Example 1

A saturated solution of ferrous chloride was prepared at room temperature, and de-aerated with nitrogen. The de-aeration was carried out in order to preclude any air oxidation. 200 mL of solution were placed in an electrolytic cell, containing a titanium cathode and a graphite anode. An anodic current density of 300 A/m² was applied, and the ferrous iron concentration was monitored via titration. No chlorine evolution was observed from the anode, and the solution rapidly turned a red colour. Because of the de-aeration, hydrogen was initially observed to be evolved from the cathode. Hydrogen evolution continued as long as ferrous iron was observed in solution, and ceased once there was no detectable ferrous iron in solution. Concurrently, chlorine evolution at the anode was noted, and after the test was stopped, a thin plate of iron foil was noted on the cathode.

This test demonstrates that electrolytic oxidation proceeds, and that it is also necessary to maintain some ferrous iron in solution to prevent the plating of metallic iron.

### Example 2

A solution containing 282 g/L ferric iron, 10.5 g/L Al, 9.96 g/L Cu, 9.61 g/L Co, 9.96 g/L Ni and 11.4 g/L Mg was heated up to 177° C. for a period of 110 minutes. Hydrochloric acid of 6M concentration was recovered. After quenching, solids analysing 64.4% Fe, 1.43% Al and 0.05%) Cu were recovered. The other metals were not detected in the solids. 56% of the HCl and 67.2% of the iron were recovered.

This demonstrates the efficiency of separating iron and aluminum from base metals, and at the same recovering hydrochloric acid.

### Example 3

A solution similar to that in Example 2 was heated to a temperature of 186° C., but allowed to react for 648 minutes. This time, there were no detectable base metals in the solids, and the iron content of the solids was 64.3%. 100% of the HCl was recovered at a concentration of 10.9M.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

What is claimed is:

1. A process for the oxidation of ferrous iron in chloride solutions and recovery of hydrochloric acid, comprising:
i. feeding a solution containing ferrous chloride and hydrochloric acid into a reactor having an anode and a cathode;
ii. applying a current to the anode and cathode to cause oxidation of the hydrochloric acid forming reactive monatomic chlorine, which immediately reacts with the ferrous iron oxidising it to ferric;
iii. heating of the so-formed ferric chloride-containing solution to effect hydrothermal decomposition of the metal chlorides contained in the solution, evolving hydrochloric acid and forming a mixture of metal oxides and basic chlorides;
iv. quenching of the so-formed decomposition slurry in dilute hydrochloric acid, wherein the basic metal chlorides re-dissolve; and
v. proceeding with solid-liquid separation of the quench slurry for the recovery of metal oxides.

2. The process of claim 1, wherein in (i), a molar ratio of ferrous iron to hydrochloric acid is >1.

3. The process of claim 2, wherein an excess hydrochloric acid is used to maintain the pH <2.0 to prevent subsequent ferric iron hydrolysis.

4. The process of claim 1, wherein in (ii), a residual ferrous iron concentration is maintained in the range 0.5-5.0 g/L.

5. The process of claim 4, wherein the residual ferrous iron concentration is maintained in the range 0.5-1.0 g/L.

6. The process of claim 1, wherein in (ii), a feed temperature is from ambient to boiling.

7. The process of claim 1, wherein in (ii), the current has a density of from 50-500 A/m².

8. The process of claim 7, wherein the current density is 300-350 A/m².

9. The process of claim 1, wherein in (iii), the ferric solution also contains a metal chloride which remains liquid at a temperature of 180-190° C.

10. The process of claim 9, wherein the metal chloride is magnesium.

11. The process of claim 9, wherein the metal chloride is calcium.

12. The process of claim 9, wherein the metal chloride is zinc.

13. The process of claim 1, wherein in (iii), the solution also contains one, any or all of aluminum, cobalt, nickel, copper, lead, manganese, titanium, or vanadium.

14. The process of claim 1, wherein in (iii), the temperature is raised to 180-190° C.

15. The process of claim 1, wherein in (iii), trivalent and higher valent metals form their oxides, which are insoluble in dilute hydrochloric acid.

16. The process of claim 15, wherein iron forms hematite and aluminum forms alumina.

17. The process of claim 1, wherein in (iii), divalent metals form their basic metal chlorides, which are readily soluble in dilute hydrochloric acid.

18. The process of claim 1, wherein in (iii), alkali metal chlorides and calcium chloride remain as chlorides, and zinc remains as a chloride.

19. The process of claim 1, wherein in (iii), the hydrochloric acid is condensed and recycled within the process.

20. The process of claim 1, wherein in (iii), the reaction is allowed to go to completion, denoted by no more HCl gas being evolved.
